(19) United States
(12) Patent Application Publication
(10) Pub. No.: US 2023/0042798 A1
(43) Pub. Date: Feb. 9, 2023

(54) VEHICLE LIFT AND PROCESS FOR LIFTING VEHICLES

(71) Applicant: Ravaglioli S.p.A., Sasso Marconi (IT)

(72) Inventors: Pasquale Digesu', Modena (IT); Sandro Ramponi, Porotto Ferrara (IT); Alberto Murru, Pianoro (IT)

(73) Assignee: Ravaglioli S.p.A., Sasso Marconi (IT)

(21) Appl. No.: 17/881,908

(22) Filed: Aug. 5, 2022

(30) Foreign Application Priority Data
Aug. 6, 2021 (IT) 102021000021509

(51) Int. Cl. B66F 7/14

(52) U.S. Cl. CPC B66F 7/14

(57) ABSTRACT

A vehicle lift comprising a column, a carriage slidably movable along the column, a movement system associated with the at least one column and configured to displace the carriage along the column. The movement system comprises an electric motor configured to drive in rotation a rotary member having a plurality of blades configured to generate an airflow during the rotation of the rotary member.

### FIELD OF THE INVENTION

The present invention relates to a vehicle lift and a method of lifting vehicles. The present invention may be used in the automotive field for servicing vehicles. For example, the present invention may be employed for lifting various types of vehicles, including cars, trucks, agricultural vehicles or others.

### BACKGROUND

Column lifts comprise one or more vertical support columns, each of which carries a carriage provided with a pair of orientable/extensible arms: the ends of the arm have pads which may be adjusted height-wise and configured to receive - resting thereon - the vehicle to be lifted. Each carriage may be displaced using an electromechanical system consisting of an electric motor active on a screw/nut screw system; the screw is arranged in the column and engaged to the nut screw associated with the carriage: the rotation of the screw generated by the electric motor allows the displacement of the nut screw and the resulting vertical sliding of the carriage along a column. The electric motor is arranged on the top of the column. The electromechanical system comprises a screw and a relative electric motor for each column, or it may comprise a screw for each column and only one electric motor: the screws are mechanically connected by a drive system. However, the Applicant observed that the electric motor of the electromechanical system, so as to able to guarantee the lifting of the vehicles, is subjected to high workloads which often generate overheating in the motor.

A first example of column lift described in U.S. Pat. No. US 4,076,216 has an electric motor arranged at the head of the column with the drive shaft thereof aligned with a screw; the drive shaft is connected by means of friction to an end of the screw. The electric motor is housed in a protection guard, provided with one or more heat dissipation fins arranged outside the guard.

A second example of lift described in French patent application no. FR2374256A1 comprises two columns, each of which stably carries an electric motor connected to a screw of the respective column: the two electric motors are controlled by means of an electronic unit configured to keep the carriages substantially at the same height. The electric motor is arranged at the head of the column without any outer protection/guard. Each electric motor is arranged beside the screw of the respective column and connected to the screw through an indirect drive system consisting of a drive pulley fixed to the drive shaft connected - by means of a belt - to a driven pulley fixed to the screw: the belt/pulley drive system allows transfer of the rotary motion of the motor to the screw. Similar two-column lifts are described in patent application nos. CN110182716A and CH635555A5.

A third example of lift, described in patent application no. WO 2006/086941 A2, comprises a column housing an electric motor whose drive shaft is connected, through a drive system, to a screw/nut screw system arranged beside the column and configured to displace a carriage along the column. Applicant observed the electric motor of the above lifts is subject to overheating and that, more in general, known lifts are susceptible of improvements.

### SUMMARY

One aspect concerns a vehicle lift comprising:
a column,
a carriage slidably engaged to the column,
a movement system associated with the column and configured to displace the carriage along the column, the movement system comprising:
   a screw extending along an extension section of the column and rotatable around an axis,
   a nut screw movable along the screw following rotation of the same screw, the carriage being engaged to and movable together with the nut screw along the screw,
   an electric motor configured for driving in rotation the screw around said axis.

In an aspect according to the preceding aspect, the movement system comprises a rotary member configured to rotate together with the electric motor and the screw.

An aspect concerns a vehicle lift comprising:
a column,
a carriage slidably engaged to the column,
a movement system configured to displace the carriage along the column, the movement system comprising a rotary member and an electric motor configured to drive in rotation said rotary member.

In an aspect according to the preceding aspect, the rotary member is connected to and rotates together with the electric motor. For example, the rotary member may be integrally joined with the electric motor. In an aspect according to any one of the two preceding aspects, the movement system comprises:
a screw extending along an extension section of the column and rotatable around an axis,
a nut screw movable along the screw following rotation of the same screw, the carriage being engaged to and movable together with the nut screw along the screw,
wherein the electric motor is kinematically connected to the screw to drive the screw in rotation around said axis.

In an aspect according to any one of the preceding aspects, the rotary member has a plurality of blades configured to generate an airflow during the rotation of the rotary member. In an aspect according to any one of the preceding aspects, the column extends, in use, along a vertical direction.

In an aspect according to any one of the preceding aspects, the rotary member, during the rotation thereof, is configured to generate a cooling airflow, optionally for one or more of the components of the movement system. In an aspect according to any one of the preceding aspects, the rotary member, during the rotation thereof, is configured to generate an airflow (optionally for cooling), impacting the electric motor.

In an aspect according to any one of the preceding aspects, the rotary member kinematically connects the electric motor to the screw. In an aspect according to any one of the preceding aspects, the rotary member is configured to transfer a rotary motion from the electric motor to the screw.

In an aspect according to any one of the preceding aspects, the rotary member is fixed to the screw or a drive shaft of the electric motor. In an aspect according to any one of the preceding aspects, the rotary member is fixed on the screw. In an aspect according to any one of the preceding aspects, the column extends between a base portion and a top portion, wherein the movement system is arranged at the top portion of the column.

In an aspect according to any one of the preceding aspects, the screw substantially extends over the entire extension of the column. In an aspect according to any one of the preceding aspects, the screw substantially extends from the base portion to the top portion of the column.

In an aspect according to any one of the preceding aspects, the screw extends between a first and a second end, wherein the first end of the screw is arranged at the base portion of the column while the second end of the screw is arranged at the top portion of the column. In an aspect according to the preceding aspect, the rotary member is fixed at the second end of the screw.

In an aspect according to any one of the preceding aspects, the rotary member comprises a number of blades equal to or greater than 3, optionally comprised between 3 and 10, even more optionally comprised between 3 and 7. In an aspect according to any one of the preceding aspects, one or more of said blades has cross-section with a wing profile. In an aspect according to any one of the preceding aspects, each blade has cross-section with a wing profile. In an aspect according to any one of the preceding aspects, the profile of at least one of said blades, optionally of all blades, of the rotary member is concave-convex, flat-convex, or laminar concave-convex.

In an aspect according to any one of the preceding aspects, the movement system comprises:
a drive member fixed to a drive shaft of the electric motor, and
a drag element which connects the drive member with the rotary member.

In an aspect according to the preceding aspect, the rotary member is driven in rotation by the drive member. In an aspect according to any one of the preceding aspects, the rotary member comprises a pulley, optionally of the dual-seat type. In an aspect according to any one of the preceding aspects, the drive member comprises a pulley, optionally of the dual-seat type, wherein the drag element comprises at least one belt.

In an aspect according to any one of the preceding aspects, the lift comprises a casing engaged to the column; the rotary member and the electric motor are at least partly housed in the casing. In an aspect according to the preceding aspect, the rotary member is at least partly arranged in the casing. In an aspect according to any one of the two preceding aspects, the casing defines, in cooperation with said at least one column, a channel configured to allow the through-flow of an airflow. In an aspect according to the preceding aspect, the channel comprises:
an inlet configured to allow the inflow of an airflow into the channel, and
an outlet configured to allow the ejection of an airflow from the channel.

In an aspect according to any one of the two preceding aspects, the electric motor is at least partly arranged in the channel. In an aspect according to any one of the three preceding aspects, the channel is configured to convey an airflow, optionally a cooling airflow, from the inlet to the outlet, impacting the electric motor. In an aspect according to the preceding aspect, the airflow flowing through the channel is generated by the rotary member and it is configured to cool the electric motor arranged in the casing.

In an aspect according to any one of the preceding aspects, the rotary member is at least partly housed in the casing. In an aspect according to any one of the preceding aspects, the rotary member is configured to generate an airflow in the channel. In an aspect according to any one of the preceding aspects, the rotary member is configured to convey said airflow from the inlet to the outlet of the casing.

In an aspect according to any one of the preceding aspects, the electric motor is entirely housed in the casing. In an aspect according to any one of the preceding aspects, the electric motor is interposed between the inlet and the outlet of the channel. In an aspect according to any one of the preceding aspects, the rotary member is entirely housed in the casing. In an aspect according to any one of the preceding aspects, the drive member and the drag element are entirely housed in the casing.

In an aspect according to any one of the preceding aspects, the casing is arranged outside the column, optionally at the top portion.

In an aspect according to any one of the preceding aspects, the casing comprises a top panel arranged at the top portion of the column, wherein a side wall emerges from the top portion, in the direction of the base portion of the same column, and wherein the top panel and the side wall delimit a compartment configured to house the electric motor. In an aspect according to the preceding aspect, the rotary member is entirely housed in the compartment of the casing. In an aspect according to any one of the two preceding aspects, the drive member and the drag element are entirely housed in the compartment of the casing. In an aspect according to any one of the three preceding aspects, at least one part of the top portion of the column is arranged in the compartment of the casing and defines, with the casing, said channel.

In an aspect according to any one of the four preceding aspects, the top panel faces the rotary member. In an aspect according to any one of the five preceding aspects, the top panel is spaced apart from and aligned with the screw along the rotation axis. In an aspect according to any one of the six preceding aspects, the side wall of the casing delimits a single passage opening traversed by the column and by the screw. In an aspect according to the preceding aspect, the passage opening of the casing faces the base portion of the column. In an aspect according to any one of the eight preceding aspects, the casing is made of a sheet, optionally made of metal material. In an aspect according to any one of the nine preceding aspects, the passage opening of the casing cooperating with the column, defines at least one of the inlet and the outlet of the channel.

In an aspect according to any one of the preceding aspects, the casing has at least one through access configured to define at least one of the inlet and the outlet of the channel. In an aspect according to any one of the preceding aspects, the at least one through access is defined on at least one of the top panel and the side wall of the casing. In an aspect according to any one of the preceding aspects, the at least one through access comprises a plurality of through accesses. In an aspect according to any one of the preceding aspects, the at least one through access is defined solely on the side wall of the casing. In an aspect according to any one of the preceding aspects, the casing has a plurality of through accesses configured to define at least one of the inlet and the outlet of the channel. In an aspect according to any one of the preceding aspects, said through accesses are defined on the side wall of the casing. In an aspect according to any one of the preceding aspects, the top panel is without through accesses.

In an aspect according to any one of the preceding aspects, the column comprises:
a base plate configured to be fixed to the ground, and
a support frame emerging from the base over the entire extension of the column.

In an aspect according to the preceding aspect, the frame defines - a seat: the screw of the movement system is housed inside the seat. In an aspect according to any one of the two preceding aspects, the support frame has, along the entire extension thereof, a cross-section with constant profile. In an aspect according to any one of the three preceding aspects, the frame has, along the entire extension thereof, a cross-section having a substantially C-shaped profile. In an aspect according to any one of the four preceding aspects, the column comprises, at the top portion, a support plate. In an aspect according to any one of the preceding aspects, the support plate is juxtaposed to the base plate with respect to the frame. In an aspect according to any one of the preceding aspects, the screw of the movement system is hinged to the support plate. In an aspect according to any one of the preceding aspects, the electric motor and the rotary member are carried by the support plate. In an aspect according to any one of the preceding aspects, the drive member is carried by the support plate. In an aspect according to any one of the preceding aspects, the rotary member is juxtaposed to the electric motor with respect to the support plate. In an aspect according to any one of the preceding aspects, the support plate is spaced from and faces the top panel of the casing. In an aspect according to any one of the preceding aspects, the support plate is entirely housed in the compartment of the casing.

In an aspect according to any one of the preceding aspects, the rotary member is made of metal and/or plastic material. In an aspect according to any one of the preceding aspects, the rotary member is at least partly, optionally entirely, made of metal. In an aspect according to any one of the preceding aspects, the rotary member is at least partly made of at least one of the following materials: steel, aluminum, plastic, composite material or a combination of the preceding materials.

In an aspect according to any one of the preceding aspects, the rotation axis of the screw passes through the center thereof. In an aspect according to any one of the preceding aspects, the rotation axis is concentric to the screw. In an aspect according to any one of the preceding aspects, the rotation axis is a central longitudinal axis of the screw.

In an aspect according to any one of the preceding aspects, the screw is of the worm screw type. In an aspect according to any one of the preceding aspects, the nut screw is arranged concentrically to the screw.

In an aspect according to any one of the preceding aspects, the carriage comprises at least one lifting arm configured to contact a vehicle, optionally the bodywork of the vehicle, to allow lifting thereof. In an aspect according to the preceding aspect, the at least one lifting arm lies substantially along a plane orthogonal to an extension direction of the column optionally orthogonal to the rotation axis of the screw. In an aspect according to any one of the two preceding aspects, the at least one lifting arm is rotatably movable around an axis parallel to an extension direction of the column. In an aspect according to any one of the three preceding aspects, the rotation axis of the at least one lifting arm is distinct and parallel to the rotation axis of the screw. In an aspect according to any one of the preceding aspects, the carriage comprises two lifting arms configured to contact a vehicle, optionally the bodywork of the vehicle, to allow lifting thereof. In an aspect according to the preceding aspect, the lifting arms lie substantially on a single plane orthogonal to the rotation axis of the screw. In an aspect according to any one of the two preceding aspects, the lifting arms are rotatably movable around respective axis parallel to an extension direction of the column, optionally distinct and parallel to the rotation axis of the screw.

In an aspect according to any one of the preceding aspects, the lift comprises a sensor configured to generate a signal representing one of the following parameters:
a rotation speed of the rotary member,
an angular position of the rotary member with respect to an initial reference position,
a number of rotations carried out by the rotary member with respect to an initial reference position,
a position of the carriage along the column,
a rotation speed of the screw,
an angular position of the screw with respect to an initial reference position,
a number of rotations carried out by the screw with respect to an initial reference position,
a height of the carriage with respect to a reference plane,
a sliding speed of the carriage along the column,
a number representing the ascent/descent cycles of the carriage, or
a number of inversions, optionally with reduced stroke, of the carriage.

In an aspect according to any one of the preceding aspects, the lift comprises a control unit connected to the electric motor. In an aspect according to the preceding aspect, the control unit is connected to the sensor. In an aspect according to the preceding aspect, the control unit is configured to:
receive the signal emitted by the sensor,
process said signal, and
determine a value of at least one of the following parameters:
   a rotation speed of the rotary member,
   an angular position of the rotary member with respect to an initial reference position,
   a number of rotations carried out by the rotary member with respect to an initial reference position,
   a position of the carriage along the column,
   a rotation speed of the screw,
   an angular position of the screw with respect to an initial reference position,
   a number of rotations carried out by the screw with respect to an initial reference position,
   a height of the carriage with respect to a reference plane,
   a sliding speed of the carriage along the column,
   a number representing the ascent/descent cycles of the carriage, or
   a number of inversions, optionally with reduced stroke, of the carriage.

In an aspect according to any one of the preceding aspects, the sensor comprises an inductive sensor. In an aspect according to any one of the preceding aspects, the sensor is configured to detect a parameter relating to the rotation of the rotary member. In an aspect according to any one of the preceding aspects, the sensor of the inductive type is configured to detect passage of the blades of the rotary member. In an aspect according to any one of the preceding aspects, the control unit is configured to detect the signal emitted by the sensor to determine, as a function of the detected passage of the blades and the rotation direction of the electric motor, a position of the carriage along the column.

In an aspect according to any one of the preceding aspects, the sensor is carried by the support plate. In an aspect according to any one of the preceding aspects, the sensor is juxtaposed to the electric motor with respect to the support plate. In an aspect according to any one of the preceding aspects, the sensor at least partly faces the rotary member.

In an aspect according to any one of the preceding aspects, the column comprises a first and a second column spaced apart and parallel with respect to each other. In an aspect according to the preceding aspect, the first and the second column are substantially identical to each other. In an aspect according to any one of the preceding aspects, the first and the second column are of the type according to any one of the preceding aspects relating to at least one column. In an aspect according to any one of the preceding aspects, the first column carries a first carriage which is slidably movable along said first column. In an aspect according to any one of the preceding aspects, the second column carries a respective second carriage which is slidably movable along said second column.

In an aspect according to any one of the preceding aspects, the screw of the movement system comprises:
a first screw associated with the first column, said first screw extending along an extension section of the first column and being rotatably movable around an axis, and
a second screw associated with the second column, said second screw extending along an extension section of the second column and being movable to rotate around a respective axis, and wherein the nut screw of the movement system comprises:
a first nut screw engaged, on one side, to the first screw and, on the other side, to the first carriage, said first nut screw, following rotation of the first screw, being movable with the first carriage along the first screw, and
a second nut screw engaged, on one side, to the second screw and, on the other side, to the second carriage, said second nut screw, following rotation of the second screw, being movable with the second carriage along the second screw.

In an aspect according to any one of the preceding aspects, the rotary member is connected to and rotates together with the electric motor, the first screw and the second screw. In an aspect according to any one of the preceding aspects, the rotary member is fixed on at least one of said first and second screw. In an aspect according to any one of the preceding aspects, the electric motor is kinematically connected to at least one of the first and the second screws.

In an aspect according to any one of the preceding aspects, the motor of the movement system comprises a first and a second electric motor kinematically connected respectively to the first and to the second screw to drive said first and second screw in rotation around the respective axes. In an aspect according to any one of the preceding aspects, the rotary member of the movement system comprises:
a first rotary member connected to and rotating with at least one of the first electric motor and the first screw, said first rotary member having a plurality of blades configured to generate, during rotation of the first rotary member, an airflow, optionally impacting the first electric motor, and
a second rotary member connected to and rotating with at least one of the second electric motor and the second screw, said second rotary member having a plurality of blades configured to generate, during the rotation of second rotary member, an airflow, optionally impacting the second electric motor.

For example, the first rotary member may be integrally joined with the first electric motor and the second rotatory member may be integrally joined with the second electric motor. In an aspect according to the preceding aspect, the first rotary member kinematically connects the first electric motor to the first screw. In an aspect according to any one of the two preceding aspects, said first rotary member is configured to transfer a rotary motion from the first electric motor to the first screw.

In an aspect according to any one of the preceding aspects, the second rotary member kinematically connects the second electric motor to the second screw. In an aspect according to any one of the preceding aspects, the second rotary member is configured to transfer a rotary motion from the second electric motor to the second screw.

In an aspect according to any one of the three preceding aspects, the first rotary member is fixed on the first screw. In an aspect according to any one of the four preceding aspects, the second rotary member is fixed on the second screw.

In an aspect according to any one of the preceding aspects, the movement system comprises:
a first drive member fixed to a drive shaft of the first electric motor,
a first drag element which connects the movement of the first drive member with the movement of the first rotary member, optionally wherein said first rotary member defines a driven member driven in rotation by the first drive member,
a second drive member fixed to a drive shaft of the second electric motor, and
a second drag element which connects the movement of the second drive member with the movement of the second rotary member, optionally wherein said second rotary member defines a driven member driven in rotation by the second drive member.

In an aspect according to any one of the preceding aspects, said first and second rotary member comprise respective pulleys, optionally of the dual-seat type. In an aspect according to any one of the preceding aspects, said first and second drive member comprise respective pulleys, optionally of the dual-seat type, while the first and second drag element comprise respective belts.

In an aspect according to any one of the preceding aspects, the lift comprises a casing for each column (optionally for each of said first and second column); in each casing a respective electric motor (optionally the first or second electric motor) is at least partly housed. In an aspect according to any one of the preceding aspects, each casing is of the type described above, optionally comprising the top panel and the side wall. In an aspect according to any one of the preceding aspects, each casing cooperates with the respective column to define a respective channel configured to allow the through-flow of an airflow. Each channel comprises:
an inlet configured to allow the inflow of an airflow into the channel, and
an outlet configured to allow the ejection of an airflow from the channel.

In an aspect according to any one of the preceding aspects, the electric motor is housed in the respective casing and arranged at least partly inside the respective channel which is configured to convey an airflow (optionally for cooling) from the inlet to the outlet, impacting said electric motor.

In an aspect according to any one of the preceding aspects, the control unit is active to control the first and second electric motor, said control unit being configured to control the first and second motor to synchronize the displacement of the carriages carried by the first and second column.

In an aspect according to any one of the preceding aspects, each of said first and second rotary member is of the type according to the rotary member described above. In an aspect according to any one of the preceding aspects, each of said first and second rotary member has a plurality of blades configured to generate, during the rotation of the rotary member, an airflow, optionally for cooling the respective electric motor.

In an aspect according to any one of the preceding aspects, the first and second electric motor are of the type according to the electric motor described above. In an aspect according to any one of the preceding aspects, the first and second drive member are of the type according to the drive member described above. In an aspect according to any one of the preceding aspects, the first and second drag element are of the type according to the drag element described above.

In an aspect according to any one of the preceding aspects, the said first and second column are of the type according to the column described above, optionally comprising the base plate and the support frame, even more optionally comprising the support plate.

In an aspect according to any one of the preceding aspects, the first and the second screw are of the type comprising the screw described above, that is housed in the frame of the respective column.

One aspect concerns a method for lifting vehicles using a lift, according to any one of the preceding aspects. In an aspect according to the preceding aspect, the method comprises the following steps:
providing the carriage in proximity of the ground,
arranging a vehicle above the lifting arm, and
actuating the electric motor to move said carriage along the column to carry the arm in contact with the vehicle and lift it with respect to the ground,
wherein, when actuating the electric motor, the rotary member rotates and generates an airflow.

In an aspect according to the preceding aspect, the airflow is a cooling flow. In an aspect according to any one of the two preceding aspects, the airflow generated by the rotary member impacts at least one component of the movement system, optionally the electric motor.

In an aspect according to any one of the preceding method aspects, the rotary member, during the actuation of the electric motor, rotates to generate an airflow in the channel, flowing in from the inlet and flowing out from the outlet, impacting the electric motor. In an aspect according to any one of the preceding method aspects, the rotary member rotates together with the screw during the displacement of the carriage along the column.

One aspect concerns a rotary member for a mechanical drive system, said rotary member comprising:
a central hub configured to be constrained to a propeller shaft, optionally a drive shaft of an electric motor,
a plurality of blades emerging from the central hub, and
a peripheral portion carried by the plurality of blades on the opposite side with respect to the central hub, wherein said peripheral contact portion is configured to connect at least one of a further rotary member and a drag element,
wherein the plurality of blades is configured to generate an airflow during the rotation of the rotary member. In an aspect according to the preceding aspect, the rotary member, during the rotation thereof, is configured to generate a cooling airflow, optionally a cooling flow for one or more components of the mechanical drive system and/or for an electric motor active on the mechanical drive system.

In an aspect according to any one of the preceding aspects, the rotary member comprises a number of blades greater than 3, optionally comprised between 3 and 10, even more optionally comprised between 3 and 7. In an aspect according to any one of the preceding aspects, one or more of said blades has a cross-section with a wing profile. In an aspect according to any one of the preceding aspects, each blade has a cross-section with a wing profile. In an aspect according to any one of the preceding aspects, the profile of at least one of said blades, optionally all blades, of the rotary member is concave-convex, flat-convex, laminar concave-convex.

In an aspect according to any one of the preceding aspects, the peripheral portion comprises at least one of: a pulley, a gear. In an aspect according to any one of the preceding aspects, the peripheral portion comprises a pulley, optionally with dual seat, configured to cooperate with a drag element, for example, a belt.

One aspect concerns a use of a rotary member for a column lift, optionally with two columns, for vehicles. In an aspect according to the preceding aspect, the rotary member is movable by at least one electric motor. In an aspect according to any one of the two preceding aspects, the rotary member has a plurality of blades configured to generate an airflow during the rotation of the rotary member, impacting the electric motor. In an aspect according to the preceding aspect, the rotary member is of the type according to any one of the preceding aspects. In an aspect according to any one of the preceding aspects, the rotary member comprises a number of blades greater than 3, optionally comprised between 3 and 10, even more optionally comprised between 3 and 7. In an aspect according to any one of the three preceding aspects, wherein each blade has a cross-section with a wing profile, optionally a concave-convex profile or flat-convex profile or laminar concave-convex profile.

One aspect concerns a use of a lift according to any one of the preceding aspects for lifting and maintenance of transport means.

### BRIEF DESCRIPTION OF THE DRAWINGS

Some embodiments and some aspects of the invention will be described hereinafter with reference to the attached exemplifying and therefore not-limiting drawings, wherein:

FIG. 1 is a perspective view of a lift according to the present invention;

FIG. 2 is a detailed lateral view of a lift according to the present invention;

FIG. 3 is a cross-sectional view, according to line III-III, of the lift of FIG. 2;

FIGS. 4 and 5 are further detailed perspective views of a lift according to the present invention;

FIG. 6 is a detailed top view of a lift according to the present invention;

FIG. 7 is a perspective view of a rotary member of the lift;

FIG. 8 is a top view of a rotary member of FIG. 7;

FIG. 9 is a cross-sectional view, according to line IX-IX, of the rotary member of FIG. 8; and

FIG. 10 is a further schematic view of the lift according to the present invention.

### DEFINITIONS AND CONVENTIONS

In the present detailed description, corresponding parts illustrated in the various figures are indicated with same reference numbers. The figures could representation that are not in scale; parts and components illustrated in the figures might be schematic representations.

The term “vertical” used relating to components of the lift, refers to a use condition during which the lift may be used for lifting/lowering a vehicle.

The lift described and claimed hereinafter may comprise/use at least one control unit 50 designed to control the operating conditions provided by the lift and/or to control the method steps for lifting a vehicle. The control unit 50 may be single unit or it may consist of a plurality of distinct control units depending on the design choices and operative needs. The expression control unit is used to indicate an electronic component which may comprise at least one of: a digital processor (CPU), an analog circuit, or a combination of one or more digital processors with one or more analogue circuits. The control unit may be “configured” or “programmed” to perform some steps: this may basically be obtained using any means which allows to configure or program the control unit. For example, should the control unit comprise one or more CPUs and one or more memories, one or more programs may be stored in appropriate memory banks connected to the CPU or to the CPUs; the program or programs contain instructions which, when run by the CPU or by the CPUs, program or configure the control unit to perform the operations herein described and relating to the control unit. Alternatively, if the control unit is or comprises an analogue circuit, then the circuit of the control unit may be designed to include a circuit configured, in use, to process electrical signals so as to perform the steps herein described and relating to the control unit.

Parts of the method described herein may be obtained by means of a data processing unit, or control unit, which may be technically replaced with one or more computers designed to run a portion of a software or firmware program loaded on a storage medium. Such software program may be written in any programming language of the known type. Two or more computers may be connected to each other through a data connection such that the computing capacity thereof is shared in any manner; therefore, the computers may even be installed in geographically different positions, creating a distributed computing environment through the aforementioned data connection.

The data processing unit, or control unit, may be a general-purpose processor configured to run one or more parts of the process identified in the present disclosure through the software or firmware program, or it may be an ASIC or dedicated process or an FPGA, specifically programmed to at least partly carry out operations of the method described herein.

The storage medium may be non-transitory, and it may be inside or outside the processor, or control unit, or data processing unit, and it may - specifically - be a memory geographically arranged remotely with respect to the computer. Furthermore, the storage medium may be physically split into several portions, or in form of cloud, and the software or firmware program may physically provide for portions stored on storage portions geographically split from each other.

### DETAILED DESCRIPTION

### Lift

Reference number 1 indicates a vehicle lift. For example, the lift may be used in the automotive industry for servicing various types of vehicles, including cars, trucks, and agricultural vehicles.

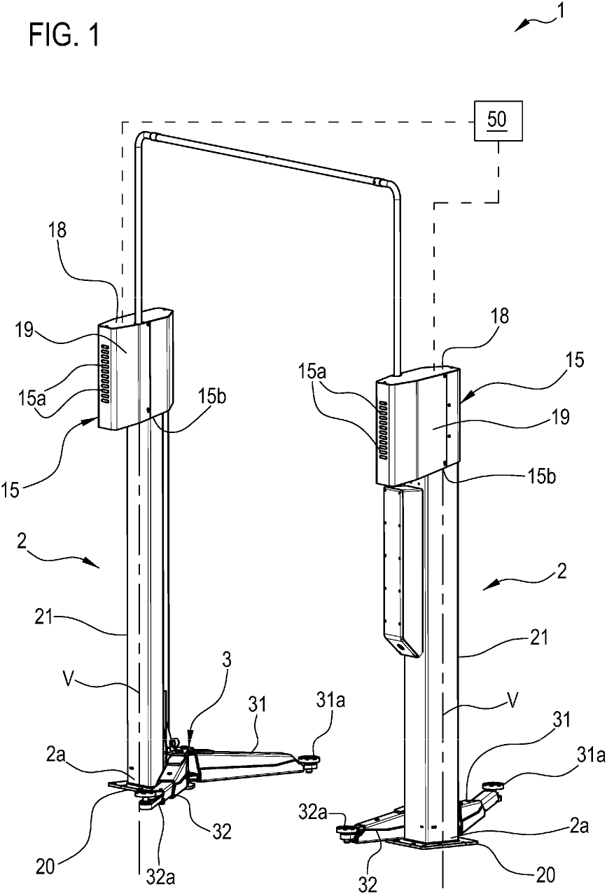

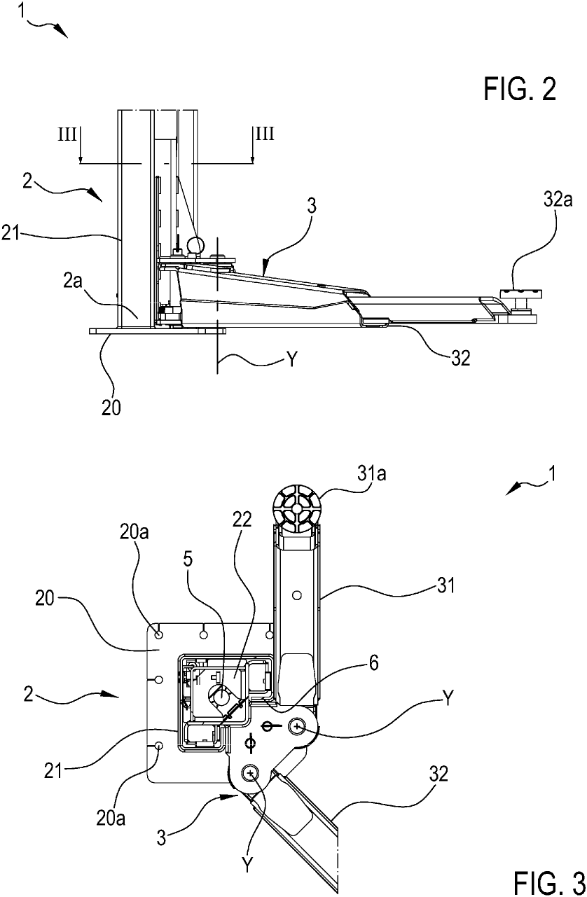

As shown in the accompanying figures, the lift 1 comprises a column 2 extending, in use, along a vertical direction between a base portion 2a and a top portion 2b (see for example FIG. 1). The column 2 defines the vertical element for supporting the lift, configured to support the vehicle suspended with respect to the ground; the column 2 may be fixed to the ground, for example using screw/bolt systems. The column 2 may comprise a base plate 20, optionally made of metal material, configured to be fixed to the ground and from which a support frame 21 emerges, also optionally made of metal material. As shown in FIG. 3, the base plate 20 comprises a plurality of holes 20a configured to receive a fastening screw, allowing to fix the column to the ground. The support frame 21 is in a single piece to the base plate 20 and it defines - therein - a seat 22 (FIG. 3) configured to receive - engaged thereto - one or more components of the lift 1.

The support frame 21 has a cross-section with constant profile, optionally having a C-shaped or substantially V-shaped profile (see for example the top view of FIG. 3). In detail, the support frame 21 is obtained by one or more sheet layers made of metal material.

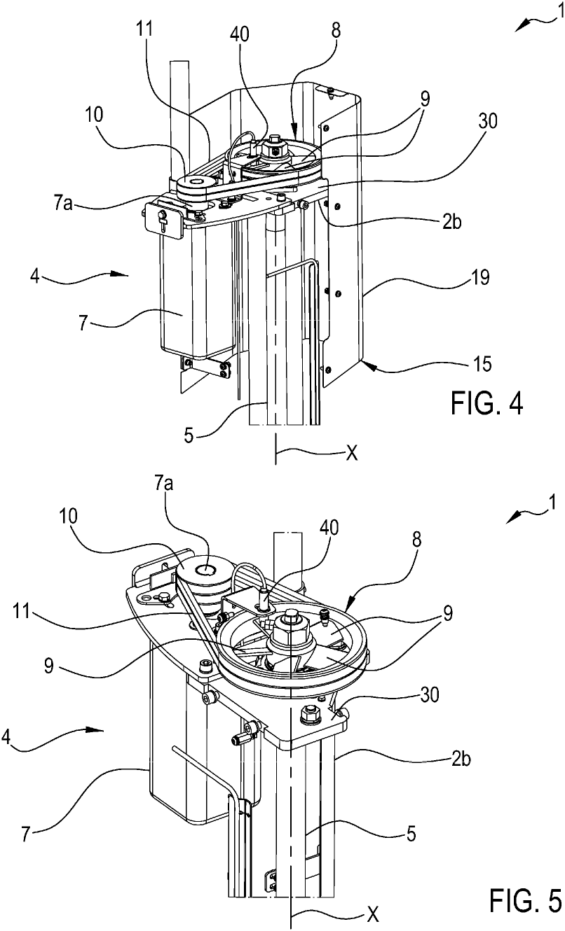

As shown in FIGS. 4 and 5, the column 2 may further comprise, optionally at the top portion 2b, a support plate 30: the support plate 30 is opposed to the base plate 20 with respect to the frame 21 and it essentially defines an end element of the column 2.

The lift 1 may comprise only one column 2, or it may comprise a plurality of columns 2 distinct and spaced from each other. FIG. 1 shows, in a non-limiting way, a lift 1 comprising two columns 2 (a first and a second column): the columns are arranged spaced from each other, and they extend along a vertical direction, parallel to each other. The columns are spaced apart to allow to position, interposed with respect to each other, a vehicle.

The lift 1 comprises a carriage 3 (FIG. 1) slidably engaged to the column 2. In detail, the lift 1 comprises a carriage 3 for each column 2; the carriage 3 defines the movable element of the lift 1, lifting and lowering the vehicle with respect to the ground, e.g., allowing an operator to work under the vehicle. The carriage 3 is movable along the column 2 approaching and moving away with respect to the base portion 2a (optionally with respect to the plate 20). The carriage 3 comprises at least one lifting arm configured to contact a vehicle, optionally the bodywork of the vehicle, to allow the lifting thereof; the arm of the carriage lies substantially along a plane orthogonal to an extension direction of the column 2. The arm may be of the orientable type that is rotatably movable around an axis Y parallel to the extension direction of the column 2: such axis Y may be arranged outside the support frame 21 (FIG. 3). Additionally or alternatively, the arm may be of the extensible type that is configured to vary the length thereof.

In a non-limiting way, the carriage 3 may comprise two lifting arms 31, 32 (FIG. 1) both configured to contact a vehicle, optionally the body of the vehicle, to allow the lifting thereof. The lifting arms 31, 32 lie substantially on a single plane orthogonal to the extension direction of the column. At least one of said lifting arms 31, 32 may be of the orientable type that is rotatably movable around a respective axis Y parallel to an extension direction of the column. By way of non-limiting example, the lift 1 shown in the attached figures has a first and second arm 31, 32 both of the orientable type; additionally or alternatively, at least one of said lifting arms 31, 32 may be of the extensible type; by way of non-limiting example, the attached figures show a first non-extensible orientable arm 31 and a second arm 32 which is both orientable and of the extensible type.

As shown in the accompanying figures, each arm carries - at the end - a support pad configured to directly contact the bodywork of the vehicle; in particular, the first and second arm carry - at the end -respective feet 31a, 32a which may be adjusted height-wise.

As specified above, the lift 1 may comprise a first and a second column. Should the lift 1 comprise only one column, it has only one carriage 3 as described above. In a non-limiting way, FIG. 1 shows a lift 1 having a first and a second column each of which comprises a carriage 3 as described above.

The lift 1 further comprises a movement system 4 (FIGS. 4 and 5) configured to move the carriage 3 along said column. In detail, the movement system 4 is configured to displace each carriage 3 along the respective column. Detailed hereinafter is a non-limiting embodiment of the movement system 4 associated with only one column 2.

The movement system 4 comprises a screw 5, of the worm screw type, extending along an extension section of the column 2 and rotatably movable around an axis X, parallel to the extension direction of the column 2; in detail, the axis X passes through the center of the screw: basically, the screw 5 is configured to rotate on itself around an axis passing through the center of the screw.

As shown in FIG. 3, the screw 5 is housed in the seat 22 of the support frame 21 and it extends along the entire frame, starting from the base portion 2a, up to the top portion 2b. In detail, the screw 5 extends between a first and a second end: the first end of the screw 5 is arranged at the base portion 2a of the column 2 while the second end of the screw 5 is arranged at the top portion of the column 2. In even greater detail, the screw 5 is hinged - at the first end - to the base plate 20 while - at the second end - it is hinged to the support plate 30 (FIGS. 4 and 5). In this manner, the screw 5 is engaged to the column 2 and movable with respect to said column around the axis X.

The movement system 4 further comprises a nut screw 6 concentrically engaged to the screw 5 and movable, following the rotation of the screw 5, along said screw: the nut screw 6 is engaged - on one side - to the screw 5 and - on the other side - it is integrally joined with carriage 3 so that the nut screw 6 and carriage 3 are movable integrally joined along the screw 5 and - as a result - along the column 2.

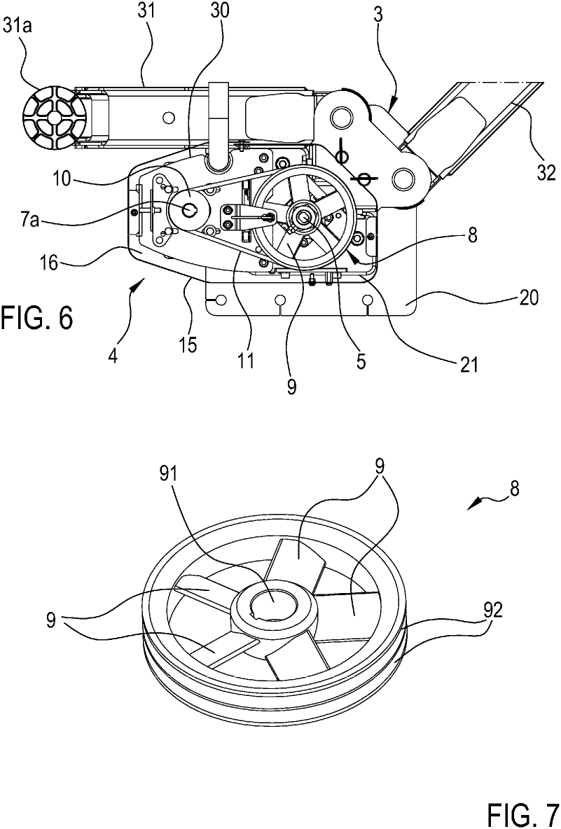

For example, as shown in FIGS. 4-6 and 10, the movement system 4 further comprises an electric motor 7 kinematically connected to screw 5. Basically, the electric motor 7 is used to control the rotation of the screw 5 so that the nut screw and carriage 3 may slide along the column 2. The electric motor 7 may have a power rating comprised between 0.5 kW and 10 kW. The electric motor 7 is carried by the column 2 and it may be arranged, at the base portion 2a or the top portion 2b. In the attached figures, the electric motor 7 is arranged, by way of non-limiting example, at the top portion 2b. The electric motor 7 may be directly constrained to the support plate 30, beside the screw 5. However, the possibility of arranging an electric motor 7 at an intermediate section of the column 2 cannot be ruled out. The electric motor 7 is arranged outside the frame 21 of the column 2, below the support plate 30, that is so that said electric motor 7 is interposed between the support plate 30 and the base plate 20.

As shown in FIGS. 4-6 and 10, the movement system 4 may further comprise a rotary member 8 connected to and rotating with at least one of the electric motor 7 and the screw 5. Basically, the rotary member 8 may be directly carried by a drive shaft of the electric motor 7 or directly carried by the screw 5; the attached figures show, in a non-limiting way, a rotary member 8 directly fixed at an end portion of the screw 5 (optionally at the second end of the screw) and configured to rotate together with said screw.

The rotary member 8 connects the electric motor 7 to the screw 5: the rotary member 8 is configured to transfer a rotary motion from the electric motor 7 to the screw 5 to allow the rotation of said screw for moving the carriage 3 along the column 2. The rotary member 8 may be made of plastic and/or metal material. For example, the rotary member 8 may be at least partly, optionally entirely, made of at least one of the following materials: steel, aluminum, plastic, composite material or a combination of the preceding materials.

As shown in the accompanying figures, the rotary member 8 has a plurality of blades 9 configured to generate, during the rotation of the rotary member 8, an airflow suitable to impact one or more components of the lift, for example further components of the movement system 4. For example, thanks to the plurality of blades 9, the rotary member 8 may be configured to generate, during the rotation of the rotary member 8, a (cooling) airflow, impacting at least one of the electric motor 7 and one or more further components of the movement system 4; for example, the movement system 4 may comprise one or more bearings suitable to support the electric motor 7, the screw 5, the nut screw 6 the rotation of the rotary member 8 allows to generate a cooling airflow suitable to impact one or more of said components so as to allow the cooling thereof.

Basically, besides acting as a member for transmitting motion between the electric motor 7 and screw 5, the rotary member 8 acts as a cooling device, for example for the electric motor 7, optionally (more generally) for one or more further components of the movement system 4. Basically, when the electric motor 7 is activated, the rotary member 8 rotates - as a result (given that the rotary member is configured to rotate together with at least one of the electric motor 7 and the screw 5) - and, thanks to the plurality of blades 9 - generates an airflow which allows to dissipate the heat, e.g., heat generated by the electric motor 7, during vehicle lifting operation.

The rotary member 8 comprises a number of blades 9 equal to or greater than 3, optionally comprised between 3 and 10, even more optionally comprised between 3 and 7. At least one blade 9, optionally each blade 9, has a cross-section with a wing profile, for example a concave-convex or flat-convex or laminar concave-convex profile. Thanks to the wing profile, the blade/blades is/are capable of generating an airflow, impacting the electric motor 7 to cool it.

In a non-limiting way, the attached figures show a movement system 4 comprising a rotary member 8 fixed on the screw 5: a drive member 10 connected to the rotary member 8 by means of a drag element 11 is fixed on the drive shaft 7a of the electric motor 7. In such embodiment, the rotary member 8 essentially defines a driven member, driven in rotation by the drive member 10 (element directly driven in rotation by the electric motor 7).

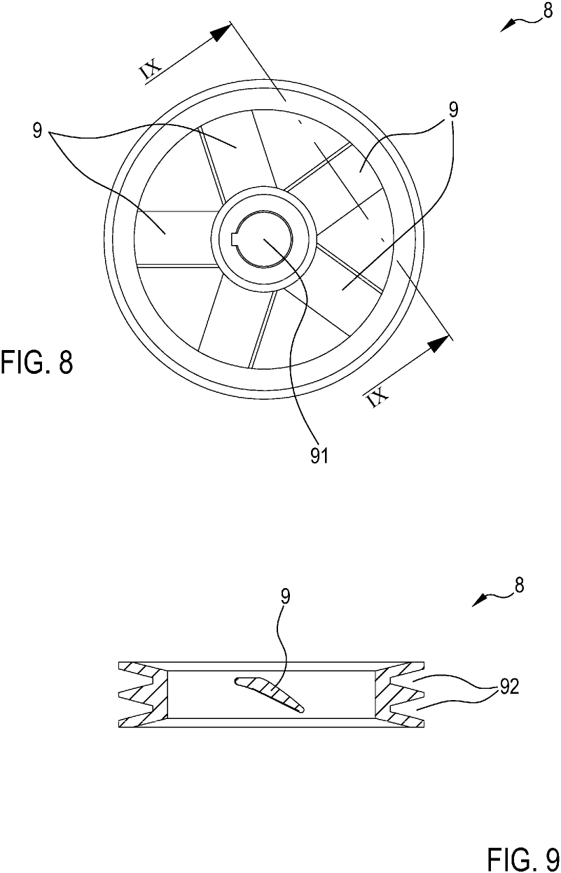

The rotary member 8 may comprise a pulley, optionally with dual-seat (see the two seats 9 of the pulley shown in FIGS. 7 and 9); the pulley has a central hub 91 configured to allow to key the pulley to the screw 5: the central hub 91 and the (dual) seat 92 of the pulley are joined together as a single piece by means of a plurality of blades 9. In such embodiment, the drive member 10 comprises a pulley, optionally with dual seat, which is suitable to cooperate with a drag element 11 comprising a belt (FIGS. 4 and 5).

The rotary member 8, the driven member 10 and the drag element 11 define an indirect belt drive system. Obviously, using an indirect chain drive system wherein the members 8 and 10 respectively comprise a crown gear and a pinion or a gear transmission cannot be ruled out. In any case, the rotary member 8 is configured to define an impeller fan also capable of acting as a member for transmitting motion.

The rotary member 8 and the drive member 10 are stably constrained to the support plate 30, for example, on the side opposite to the electric motor 7 (FIGS. 4 and 5); the drag element 11 is also arranged juxtaposed to the electric motor 7 with respect to the support plate 30. The possibility of providing an electric motor 7 on the same side as the support plate 30 on which also the rotary member 8 and, optionally, the drive member 10 are arranged, cannot be ruled out.

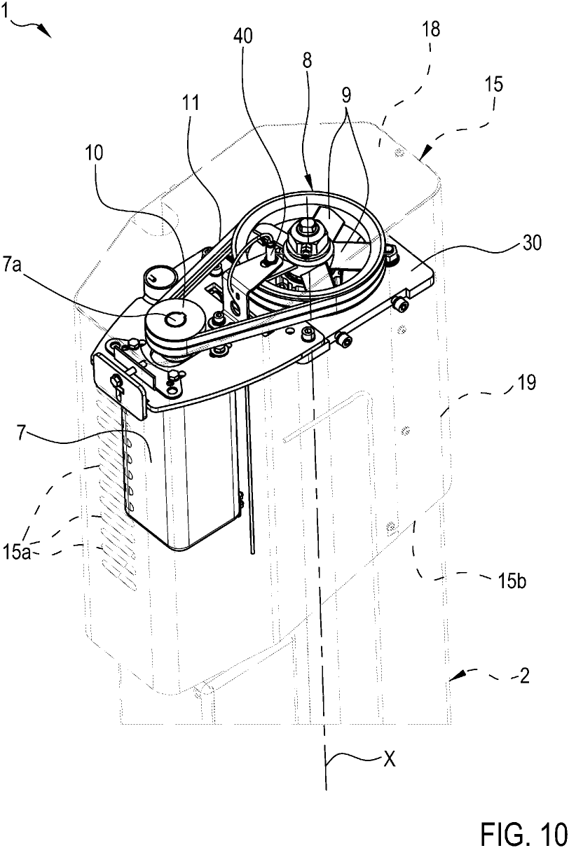

As shown in FIG. 10, the lift 1 may comprise a casing 15 engaged to the column 2; the electric motor (optionally one or more components of the movement system 4, e.g., one of more bearings for supporting the rotary member 8) is at least partly housed in the casing 15. The casing 15 may be arranged at the top portion of the column 2; the casing 15 may define, in cooperation with said column 2, a channel configured to allow the through-flow of an airflow. In detail, the channel may comprise:
an inlet 15a configured to allow the inflow of an airflow into the channel, and
an outlet 15b configured to allow the ejection of an airflow from the channel.

The airflow flowing through from the channel, from the inlet 15a to the outlet 15b, may be generated by the rotation of the rotary member 8 during the operation of the electric motor 7. The operation of the electric motor 7 drives in rotation the rotary member 8 which, thanks to the blades 9, generates an airflow in the channel: any component arranged in the channel is impacted (therefore cooled) by the airflow generated by the rotary member 8. For example, the electric motor 7 (optionally the bearing for supporting the rotary member 8) is arranged in the channel: in this manner, the electric motor 7, during the operation thereof, is impacted by an airflow which allows to dissipate the heat which may be generated by the electric motor and therefore cool said electric motor to avoid unwanted overheating.

In detail, the casing 15 may comprise a top panel 18 arranged at the top portion 2b of the column 2 from which a side wall 19 emerges; the side wall emerges from the top panel towards the base portion 2a of the same column 2. The top panel 18 and side wall 19 delimit a compartment 16 configured to house the electric motor 7. Basically, the electric motor 7 is entirely housed in the compartment 16 of the casing, together with the rotary member 8 (optionally also the support plate 30, the drive member 10 and the drag element 11 are entirely arranged in the compartment 16): as observable in FIG. 10, the support plate 30 is entirely housed in the compartment 16 of the casing 15, spaced from and facing the top panel 18.

As shown in FIG. 10, the top portion 2b of the column, together with the casing 15, define the channel: the side wall 19 of the casing 15 delimits a single passage opening traversed by the column portion 2 and by the screw 5 of the movement system 4 (the top portion of the column is arranged in the compartment 16). The passage opening is faced toward the base portion 2a: said passage opening, cooperating with the frame 21 of the column 2, defines at least one of the inlet 15a and the outlet 15b of the channel. Furthermore, the casing 15 has at least one through access configured to define at least one of the inlet 15a and the outlet 15b of the channel; the at least one through access is defined on at least one of the top panel 18 and the side wall 19 of the casing. In the attached figures, the through access has been shown, by way of non-limiting example, only on the side wall 19 (the top panel 18 has been schematized, by way of non-limiting example, as without through accesses); obviously, the possibility of providing a through access on at least one of the side wall 19 and the top panel 18 cannot be ruled out. For example, as shown in FIG. 10, the casing 15 may comprise a plurality of through accesses.

The accompanying figures show, in a non-limiting way, the inlet 15a of the channel defined on the casing (optionally defined by the through accesses of the casing 15) and an outlet defined by the cooperation between the casing 15 and the frame 21 of the column 2. The arrangement of the inlet and outlet depends on the rotation direction of the rotary member 8; for example:
the inlet 15a of the channel may be defined by the through accesses of the casing 15 while the outlet 15b would be defined by the cooperation between the casing 15 and frame 21 of the column 2, or
the inlet 15a of the channel may be defined by the cooperation between the casing 15 and frame 21 of the column 2 while the outlet 15b would be defined by the through accesses of the casing 15.

As specified above, the airflow allows to cool the electric motor 7, arranged in the channel. Obviously, the possibility of generating an airflow configured to cool - besides the electric motor 7 - any other component arranged in the channel, such as for example a bearing for supporting the rotary member 8, cannot be ruled out. Obviously, the possibility of arranging an electric motor outside the casing 15 cannot be ruled out; in such embodiment, the airflow which may be generated by the rotary member 8 (arranged inside the casing 15) would impact only the components arranged in the channel, e.g., a bearing for supporting the rotary member 8.

The lift 1 may comprise a sensor 40 (FIGS. 4-6 and 10), for example an inductive sensor, carried by the support plate 30. The sensor 40 is configured to emit a representative signal relating to the rotary member 8, for example at least one of: a rotation speed of the rotary member 8, an angular position of the rotary member 8 with respect to an initial reference position, a number of rotations carried out by the rotary member 8 with respect to an initial reference position, a rotation speed of the screw 5, angular position of the screw 5 with respect to an initial reference position, a number of rotations carried out by the screw 5 with respect to an initial reference position. Obviously, the possibility of using a different sensor associated with the column 2 and emitting a representative signal directly relating to the carriage 3, for example at least one of: a position of the carriage 3 along the column 2, a height of the carriage 3 with respect to the plane, in use, for resting the column 2, a sliding speed of the carriage 3 along the column 2, cannot be ruled out.

The lift 1 may comprise a control unit 50 connected to the sensor 40 and configured to receive and process the representative signal emitted by said sensor; the control unit, as a function of said signal, determines a position and/or a sliding speed of the carriage 3 along the column 2. Furthermore, the control unit 50 is active to control the electric motor 7 and, as a function of the representative signal emitted by the sensor 40, it may control the electric motor 7 to manage the position and sliding speed of the carriage along the column 2.

As described above, the lift 1 may comprise a first and a second column, each according to the column 2 described above that is comprising a base plate 20, a support frame 21, optionally a support plate 30. Should the lift 1 have a first and second column, it may comprise two electric motors 7, that is a first and second electric motor, each of which is carried by a respective column 2 and configured to displace a respective carriage 3. In this case, the movement system 4 may comprise a first screw (according to the screw 5 described above) engaged to a first nut screw (according to the nut screw 6 described above): the first nut screw is engaged - on one side - to the first screw and - on the other side - to a first carriage carried by the first column. Fixed on the first screw is a first rotary member (according to the rotary member 8 described above): the first rotary member is driven in rotation by a first drag element (according to the drag element 11 described above) connected to a first drive member (according to the drive member 10 described above) fixed on the first electric motor (according to the electric motor 7 described above). Basically, the first carriage 3 is displaced by the first electric motor.

Likewise, the movement system 4 may comprise a second screw (according to the screw 5 described above) engaged to a second nut screw (according to the nut screw 6 described above): the second nut screw is engaged - on one side - to the second screw and - on the other side - to a second carriage carried by the second column. Fixed on the second screw is a second rotary member (according to the rotary member 8 described above): the second rotary member is driven in rotation by a second drag element (according to the drag element 11 described above) connected to a second drive member (according to the drive member 10 described above) fixed on second electric motor (according to the electric motor 7 described above). Basically, the second carriage 3 is displaced by the first electric motor.

In the embodiment described above, each carriage is independently moved by a respective electric motor. In such embodiment, the lift 1 may comprise a casing 15 for each electric motor. As described above, the casing 15, cooperating with the respective column 2, is configured to define the channel suitable to allow the through-flow of air between the inlet 15a and the outlet 15b, useful for cooling one or more components of the movement system 4, for example of the respective electric motor 7.

In such embodiment, the control unit 50 may be connected to both electric motors for synchronizing, in a per se known manner, the displacement of the carriages along the first and second column.

Alternatively, the lift 1 may comprise only one electric motor 7 sole associated with one of the first and the second column. The column 2 carrying the electric motor is of the type described above while the first electric motor may solely comprise: the column, carrying a carriage 3, a screw 5 housed in the column 2, a nut screw 6 slidably engaged to the carriage 3 and to the screw 5. The screws 5 of the two columns are connected to each other, in a per se known manner, by means of a drive system, for example a chain drive system: in such embodiment, the activation of the single electric motor 7 may allow the displacement of the screws of the first and second column. The lift 1 may comprise a casing 15 for each electric motor 7, that is a single casing 15 for the single electric motor.

### Method of Lifting Vehicles

Furthermore, forming an object of the present invention is a method of lifting vehicles using a lift according to the description reported above and/or according to the attached claims.

The method envisages the following steps:
providing a carriage 3 in proximity of the ground,
arranging a vehicle above the at least one lifting arm,
actuating an electric motor 7 of the lift 1 to displace said carriage 3 along the column to carry the at least one lifting arm in contact with the vehicle and lift it with respect to the ground.

During the actuation of the electric motor 7, the rotary member 8 rotates and generates an airflow, impacting one or more components of the movement system 4, for example at least one of the electric motor 7 and a bearing supporting said rotary member 8. Should the lift 1 have the casing 15, during the actuation of the electric motor 7, the rotary member 8 rotates to generate - inside the channel - an airflow flowing in from the inlet 15a and flowing out from the outlet 15b, impacting one or more components of the movement system, for example at least one of the electric motor 7 and a bearing supporting the rotary member 8.

### Advantages

The present invention offers significant advantages with respect to the state-of-the-art solutions. The rotary member 8 may be used for displacing the screw 5 and the corresponding carriage 3 and, at the same time, for generating a cooling airflow (for example for the electric motor 7); the rotary member 8 capable of generating a cooling airflow (for example impacting the electric motor 7) avoids overheating, therefore providing an extremely safe and reliable lift.

1. A vehicle lift comprising:
a column,
a carriage engaged to the column and slidably movable along said column, said carriage comprising a lifting arm configured to contact and lift a vehicle, and
a movement system associated with the column and configured to move the carriage along said column, the movement system comprising:
a rotary member,
an electric motor configured to rotate the rotary member,
wherein the rotary member has a plurality of blades configured to generate an airflow during rotation of the rotary member.

2. The vehicle lift of claim 1, wherein the movement system comprises:
a screw extending along an extension section of the column and rotatably movable around an axis, and
a nut screw movable along the screw following rotation of the same screw, said nut screw being engaged to the carriage and movable together with said carriage along the screw,
wherein the electric motor is kinematically connected to the screw to drive in rotation said screw, and
wherein the rotary member is configured to rotate together with at least one of the electric motor and the screw.

3. The vehicle lift of claim 2, wherein the rotary member kinematically connects the electric motor to the screw to transfer a rotary motion from the electric motor to said screw.

4. The vehicle lift of claim 3, wherein the rotary member is directly fixed to the screw.

5. The vehicle lift of claim 1, wherein the column extends between a base portion and a top portion, wherein the movement system is arranged at the top portion of the column,
wherein the screw extends between a first and a second end, wherein the first end of the screw is arranged at the base portion of the column whereas the second end of the screw is arranged at the top portion of the column, and
wherein the rotary member is fixed at the second end of the screw.

6. The vehicle lift of claim 1, wherein the movement system comprises:
a drive member fixed to a drive shaft of the electric motor, and
a drag element connecting movement of the drive member with rotation of the rotary member, wherein the rotary member is driven in rotation by the drive member.

7. The vehicle lift of claim 6, wherein the rotary member comprises a pulley, wherein the drive member comprises a pulley, and wherein the drag element comprises a belt.

8. The vehicle lift of claim 1 comprising a casing engaged to the column, wherein the rotary member is at least partly housed inside the casing, and
wherein said casing defines, in cooperation with the column, a channel having an inlet configured to receive the airflow generated by the rotary member, and
an outlet configured to eject the airflow from the channel.

9. The vehicle lift of claim 8, wherein the electric motor is at least partly arranged inside the channel which is configured to direct said airflow moving from the inlet to the outlet to impact said electric motor.

10. The vehicle lift according of claim 8, wherein the electric motor is entirely housed in the casing between the inlet and the outlet of the channel, and wherein the rotary member is entirely housed in the casing.

11. The vehicle lift according of claim 8, wherein the casing is arranged outside a top portion of the column.

12. The vehicle lift claim 1, wherein the rotary member comprises a number of blades comprised between 3 and 10.

13. The vehicle lift according of the claim 1, wherein said blades of the rotary member have cross-section with a wing profile.

14. The vehicle lift of claim 1, wherein the column comprises a first column and a second column spaced apart and parallel with respect to each other, wherein the first column carries a first carriage which is slidably movable along said first column, and wherein said second column carries a second carriage which is slidably movable along said second column,
wherein the movement system comprises:
a first screw associated with the first column, said first screw extending along at least one extension section of the first column and being rotatably movable around an axis,
a first nut screw engaged, on one side, to the first screw and, on the other side, to the first carriage, said first nut screw following rotation of the first screw, being movable together with the first carriage along the first screw,
a second screw associated with the second column, said second screw extending along at least one extension section of the second column and being movable to rotate around a respective axis, a second nut screw engaged, on one side, to the second screw and, on the other side, to the second carriage, said second nut screw, following rotation of the second screw, being movable together with the second carriage along the second screw,
and wherein the rotary member is connected to and rotates together with the electric motor, the first screw and the second screw, the electric motor being connected to at least one of the first and the second screw to rotate said first and second screws around respective axes.

15. A vehicle lift comprising:
a column,
a carriage engaged to the column and slidably movable along said column, said carriage comprising at least one lifting arm configured to contact a vehicle,
a movement system associated with the column and including at least one electric motor configured to move the carriage along said column, and
a casing engaged to the column, wherein the electric motor is at least partly housed inside the casing, and wherein said casing cooperates with the column defining a channel, said channel comprising:
an inlet configured to receive an airflow into the channel, and
an outlet configured to eject the airflow from the channel.

16. The vehicle lift of claim 15, wherein the movement system includes a rotary member having a plurality of blades configured to generate said airflow during the rotation of the rotary member, wherein the electric motor is configured drive in rotation said the rotary member,
wherein the electric motor and the rotary member are entirely housed inside the casing, the electric motor being arranged inside the channel which is configured to direct said airflow moving from the inlet to the outlet to impact said electric motor.

17. The vehicle lift of claim 16, wherein the movement system comprises:
a screw extending along an extension section of the column and rotatably movable around an axis, and
a nut screw movable along the screw following rotation of the same screw, said nut screw being engaged to the carriage and movable together with said carriage along the screw, and
wherein the rotary member is directly fixed to the screw.

18. The vehicle lift of claim 16, wherein the movement system comprises:
a drive member fixed to a drive shaft of the electric motor, and
a drag element which connects the movement of the drive member with the rotation of the rotary member,
wherein the rotary member defines a driven member rotated by the drive member.

19. A vehicle lift comprising:
a column,
a carriage slidably movable along said column, said carriage carrying at least one lifting arm configured to contact a vehicle,
an electric motor configured to drive motion of the carriage along said column, and
a rotary member having a plurality of blades configured, during rotation of the rotary member, to generate an airflow directed to the electric motor.

20. The vehicle lift of claim 19, comprising a casing defining a channel, wherein the electric motor is configured drive the rotary member in rotation, and wherein the electric motor is housed inside the channel which is configured to direct said airflow moving from a channel inlet to a channel outlet to impact said electric motor.
